(19) United States
(12) Patent Application Publication
(10) Pub. No.: US 2021/0235164 A1
(43) Pub. Date: Jul. 29, 2021

(54) IMAGE SHARING METHOD AND DEVICE

(71) Applicant: LINKFLOW CO., LTD, Seoul (KR)

(72) Inventors: Young Kuk KIM, Gyeonggi-do (KR); Sung Rae CHO, Seoul (KR); Yong Jin KIM, Busan (KR); Jun Se KIM, Gyeonggi-do (KR)

(21) Appl. No.: 17/250,109

(22) PCT Filed: Jun. 9, 2019
(86) PCT No.: PCT/KR2019/006916

§ 371 Date: Nov. 30, 2020

(30) Foreign Application Priority Data
Aug. 9, 2018 (KR) 10-2018-0092938
Sep. 12, 2018 (KR) 10-2018-0109022

(51) Int. Cl. H04N 21/4788; H04N 21/4363

(52) U.S. Cl. CPC H04N 21/4788; H04N 21/43637

(57) ABSTRACT

An image sharing method and device can comprise the steps of: connecting to a relay user device on the basis of a first communication network by a target user device; and receiving image data, which has been generated through image capturing by an image processing device, by the target user device in real time on the basis of the first communication network, wherein the image processing device and the relay user device may be connected on the basis of a second communication network.

### TECHNICAL FIELD

The present invention relates to a video sharing method and device, and more particularly, to a method of sharing a video among user devices using a relay device.

### BACKGROUND ART

An omnidirectional video system refers to a video system which can record video information in all directions (360 degrees) on the basis of a specific view point. Since the omnidirectional video system can obtain a video having a much wider field of view than the existing video systems, recent application of omnidirectional video systems is gradually expanding to research fields, such as computer vision and mobile robots, and practical fields such as surveillance systems, virtual reality systems, pan-tilt-zoom (PTZ) cameras, and video conferences.

A variety of methods can be used to obtain an omnidirectional video. For example, an omnidirectional video may be generated by splicing videos obtained by rotating one camera about an optical axis which satisfies a single view point. Alternatively, a plurality of cameras may be arranged in a circular structure, and videos obtained from the cameras may be combined. A user may generate an omnidirectional video using various omnidirectional video processing devices (an omnidirectional video processing camera or a 360-degree camera).

Omnidirectional video processing devices may be used in various domains. For example, an omnidirectional video processing device may be used in a domain which requires omnidirectional video surveillance, such as crime prevention or security, or may be used for recording a place that a traveler visits during a vacation. In addition, an omnidirectional video captured on the basis of an omnidirectional video processing device may be edited and then used as a video for product sales.

When a video captured through an omnidirectional video processing device can be immediately checked through a user device, the omnidirectional video processing device may be used for various uses.

Consequently, it is necessary to develop a technology for a user to use an omnidirectional video, which is generated on the basis of an omnidirectional video processing device, in various fields through various types of processing.

### DISCLOSURE

### Technical Problem

The present invention is directed to solving all the problems described above.

The present invention is also directed to transmitting a video (e.g., an omnidirectional video) to a target user device through a relay device such as a user device.

The present invention is also directed to enabling a remote user of a target user device to remotely know a situation at the location of a video processing device in common with others by receiving a video captured by a video processing device in real time.

The present invention is also directed to preventing network load and video lag by minimizing unnecessary video data when sharing a video.

### Technical Solution

Representative configurations of the present invention for achieving the objectives are as follows.

One aspect of the present invention provides a video sharing method, the method comprising connecting a target user device to a relay user device on the basis of a first communication network and receiving, by the target user device, video data, which is generated through imaging by a video processing device, in real time on the basis of the first communication network, wherein the video processing device and the relay user device are connected on the basis of a second communication network.

Another aspect of the present invention provides a target user device for video sharing, the target user device comprising a communication unit configured to receive video data and a processor operatively connected to the communication unit, wherein the processor is connected to a relay user device on the basis of a first communication network and receives video data, which is generated through imaging by a video processing device, in real time on the basis of the first communication network and the video processing device and the relay user device are connected on the basis of a second communication network.

### Advantageous Effects

According to the present invention, a video (e.g., an omnidirectional video) can be transmitted to a target user device through a relay device such as a user device.

Also, according to the present invention, a remote user of a target user device can remotely know a situation at the location of a video processing device in common with others by receiving a video captured by a video processing device in real time.

Also, according to the present invention, network load and video lag are prevented by minimizing unnecessary video data when sharing a video.

### DESCRIPTION OF DRAWINGS

FIG. 1 is a conceptual diagram illustrating a video sharing method according to an embodiment of the present invention.

FIG. 2 is a conceptual diagram illustrating a method of transmitting a video on the basis of a user device according to an embodiment of the present invention.

FIG. 3 is a conceptual diagram illustrating a method of transmitting a video on the basis of a user device according to an embodiment of the present invention.

FIG. 4 is a conceptual diagram illustrating a method of transmitting a video through a user device according to an embodiment of the present invention.

FIG. 5 is a conceptual diagram illustrating a method of transmitting a video through a user device according to an embodiment of the present invention.

FIG. 6 is a conceptual diagram illustrating a method of checking a video through a remote user device according to an embodiment of the present invention.

FIG. 7 is a conceptual diagram illustrating a method of receiving a video of a specific field of view selected by a target user according to an embodiment of the present invention.

FIG. 8 is a conceptual diagram illustrating a method of checking a video in a target user device according to an embodiment of the present invention.

### MODES OF THE INVENTION

In the following detailed description of the present inventive concept, references are made to the accompanying drawings that show, by way of illustration, specific embodiments in which the present inventive concept may be practiced. These embodiments are described in sufficient detail to enable those skilled in the art to practice the present inventive concept. It is to be understood that the various embodiments of the present inventive concept, although different from each other, are not necessarily mutually exclusive. For example, specific shapes, structures and characteristics described herein may be implemented as modified from one embodiment to another without departing from the spirit and scope of the present inventive concept. Furthermore, it shall be understood that the locations or arrangements of individual components within each embodiment may also be modified without departing from the spirit and scope of the present inventive concept. Therefore, the following detailed description is not to be taken in a limiting sense, and the scope of the present inventive concept is to be taken as encompassing the scope of the appended claims and all equivalents thereof. In the drawings, like reference numerals refer to the same or similar elements throughout the several views.

Hereinafter, preferred embodiments of the present inventive concept will be described in detail with reference to the accompanying drawings to enable those skilled in the art to easily implement the present inventive concept.

In exemplary embodiments of the present invention, for convenience of description, a video processing device is assumed to be an omnidirectional video processing device, and a video captured by a video processing device is assumed to be an omnidirectional video.

However, a video processing device in a video sharing method and device according to the exemplary embodiments of the present invention may include video processing devices having various view angles as well as an omnidirectional video processing device, and captured videos may include videos having various view angles as well as omnidirectional videos.

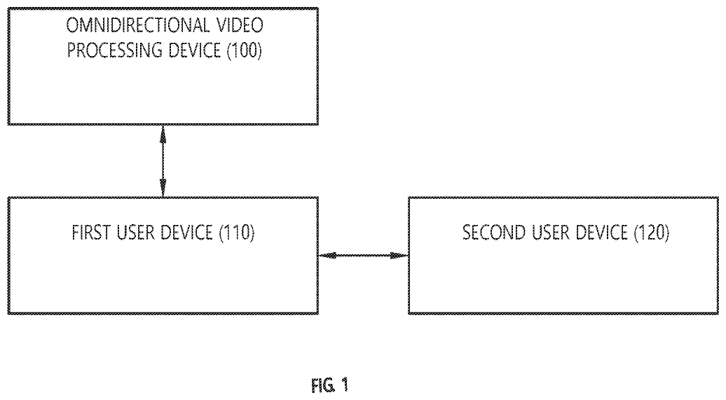

FIG. 1 is a conceptual diagram illustrating a video sharing method according to an embodiment of the present invention.

FIG. 1 shows a method of transmitting a video (e.g., an omnidirectional video) captured by a video processing device (e.g., an omnidirectional video processing device) to a target user device through a relay user device. The target user device may be a device which is not directly connected to the video processing device and receives a video captured by the video processing device.

Referring to FIG. 1, a relay user may wear a video processing device 100 and carry a relay user device 110.

As a wearable video processing device, the video processing device according to the embodiment of the present invention is assumed to be wearable by the relay user in the form of a neckband or the like. However, the video processing device according to the embodiment of the present invention may not only be such a wearable form of a video processing device but may also be other various forms of video processing devices. Also, the video processing device may not only be a video processing device for capturing a 360-degree video but may also be a video processing device for capturing a video having a view angle less than or equal to 360 degrees.

For convenience of description, it is assumed that the relay user wears the video processing device 100 and carries the relay user device 110, but a relay user who wears the video processing device 100 and a user who carries the relay user device 110 may be different from each other.

A target user may carry a target user device 120 and receive a video captured by the video processing device 100. For convenience of description, it is assumed that one user wears the video processing device 100 and carries the relay user device 110, but a user who wears the omnidirectional video processing device 100 and a user who carries the relay user device 110 may be different from each other.

Omnidirectional video data generated through imaging by the video processing device 100 may be transmitted to the target user device 120 through the relay user device 110.

The target user may remotely check an omnidirectional video of a current situation of the relay user through the target user device 120.

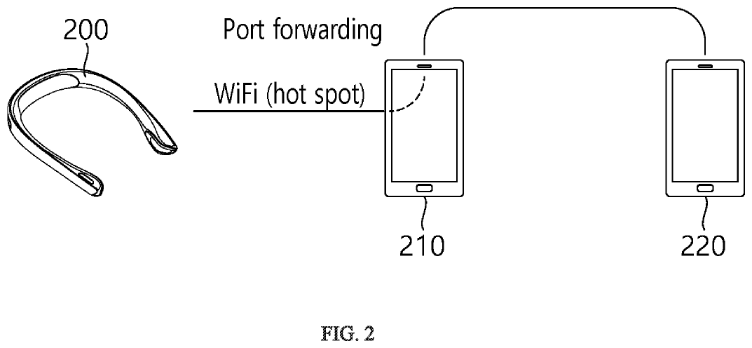

FIG. 2 is a conceptual diagram illustrating a method of transmitting a video on the basis of a user device according to an embodiment of the present invention.

FIG. 2 shows a video checking method based on a target user device. An example of a communication procedure is illustrated in FIG. 2, and various other methods may be used to check a video through a target user device. As described above, a video processing device may include an omnidirectional video processing device, and a video may include an omnidirectional video.

Referring to FIG. 2, a video processing device 200 may operate.

Between the video processing device 200 and a relay user device 210, a first communication connection may be established. For example, the relay user device 210 may serve as a router on the basis of a function such as a hot spot function. The video processing device 200 may be combined with the relay user device 210 which serves as a router.

A target user device 220 may be externally connected to the video processing device 200 on the basis of port forwarding.

Port forwarding or port mapping is a network address translation (NAT) technology for redirecting a communication request from one Internet protocol (IP) address and port number combination to another while the packets are traversing a network gateway such as a router or firewall.

For example, the relay user device 210 may set an IP address to PhoneA and a port number to PhoneA for the video processing device 200 and connect the video processing device 200 and the target user device 220 through the port forwarding technology.

The target user device 220 may receive video data transmitted through the video processing device 200 by inputting the IP address and the port number set by the relay user device. Alternatively, information on the IP address and the port number is automatically transferred between the relay user device 210 and the target user device 220 through an application so that the target user device may receive data generated by the video processing device without any input.

The target user device 220 may check a video which is captured by the video processing device 200 which transmits the video on the basis of a video transmission protocol such as the real-time streaming protocol (RTSP).

Port forwarding and the RTSP are exemplary, and the video may be shared in various ways.

In other words, the video sharing method according to the embodiment of the present invention may include an operation in which a target user device connects itself to a relay user device on the basis of a first communication network and an operation in which the target user device receives video data, which is generated through imaging by a video processing device, on the basis of the first communication network in real time. Here, the video processing device and the relay user device may be connected on the basis of a second communication network.

In this case, the first communication network may be generated on the basis of IP address information and port information of the target user device which are set by the relay user device on the basis of port forwarding, and the second communication network may be generated on the basis of the hot spot function of the relay user device.

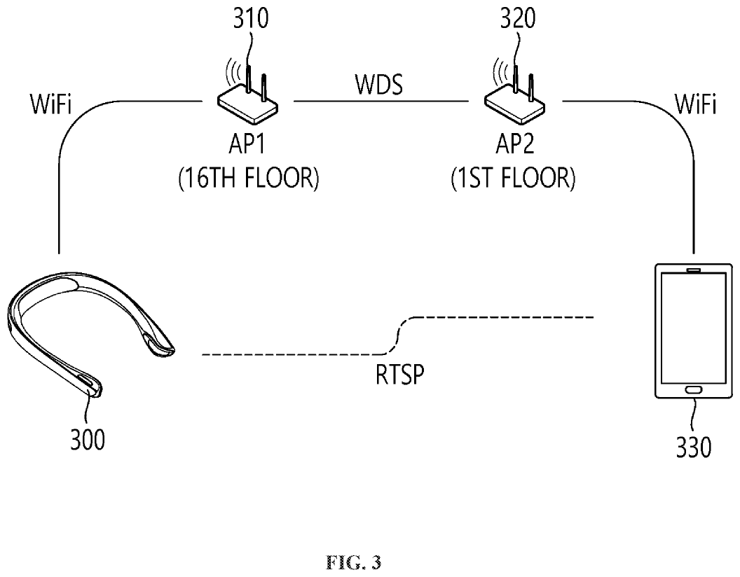

FIG. 3 is a conceptual diagram illustrating a method of transmitting a video on the basis of a user device according to an embodiment of the present invention.

FIG. 3 shows a method of communicating between a video processing device and a user device through at least one access point (AP).

Referring to FIG. 3, a video processing device 300 (e.g., an omnidirectional video processing device) starts operating and captures a video (e.g., an omnidirectional video).

AP1 310 and AP2 320 may be connected in a wireless distribution system (WDS) manner.

The video processing device 300 and AP1 310 may be connected, and a user device 330 and AP2 320 may be connected.

In an application, the user device 330 may input an internal IP address and a port number of the video processing device 300. When the user device inputs the internal IP address and the port number of the video processing device 300, the user device 330 may check a video captured by the video processing device through the RTSP. The internal IP address and the port number of the video processing device 300 may be automatically input on the basis of an application without any input to the user device.

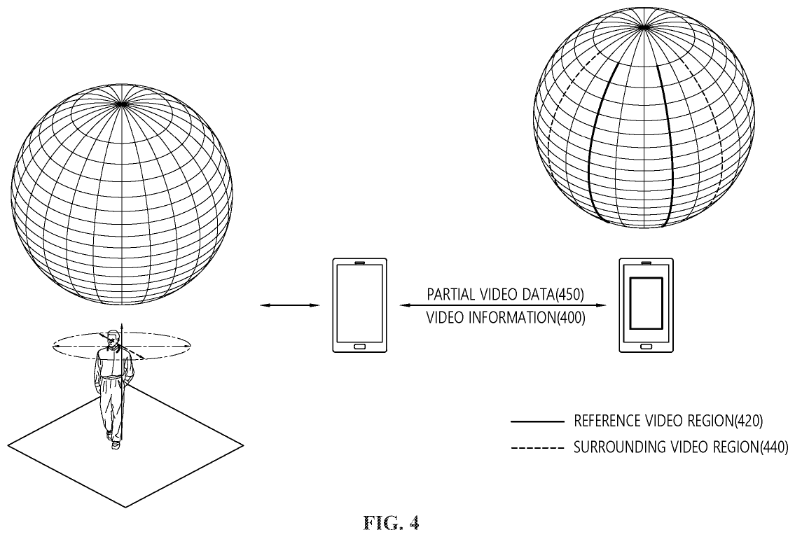

FIG. 4 is a conceptual diagram illustrating a method of transmitting a video through a user device according to an embodiment of the present invention.

FIG. 4 shows a method of reducing the size of transmitted video data in the method of transmitting a video on the basis of a user device. It is assumed below that a video processing device is an omnidirectional video processing device and a video is an omnidirectional video (a 360-degree video).

Referring to FIG. 4, disclosed is a method of reducing the amount of video data which is transmitted in real time by providing a target user device with only a video corresponding to a partial view angle of an omnidirectional video transmitted to a relay user device.

To the relay user device directly connected to the video processing device, all video data corresponding to the entire view-angle video (e.g., a 360-degree video) captured by the video processing device may be transmitted.

However, a video checked by a target user device may not be the entire view-angle video and may be a partial view-angle video in which a target user is interested in the entire view-angle video. Consequently, video data transmitted by the relay user device may be partial video data 450 of a partial view angle in which the target user is interested rather than the entire view-angle video data. In this way, the load on a communication network can be reduced, and it is possible to prevent data from unnecessarily lagging due to data load.

The target user device may transmit video information 400 of an output video, which is currently output by the target user device through an application, to the relay user device. The video information 400 may include information on the view angle of the output video output by the target user device.

For example, when the target user device outputs a video corresponding to a view angle of −30 degrees to +30 degrees on the basis of a reference point (a 0-degree point) in a 360-degree video, the video information 400 may include information indicating the view angle of −30 degrees to +30 degrees as view angle information of the output video. The target user device may transmit the video information 400 to the relay user device.

The relay user device may receive the video information 400 and determine the partial video data 450 to be transmitted to the target user device on the basis of the video information.

For example, the relay user device may transmit not only a reference video region 420 determined on the basis of the view angle information of the output video included in the video information 400 but also a surrounding video region 440 of the reference video region 420 to the target user device.

For example, the reference video region 420 may be a video region of the view angle of −30 degrees to +30 degrees indicated by the target user device, and the surrounding video region 440 may be obtained by deviating the view angle of −30 degrees to +30 degrees by a threshold percentage (e.g., a video region corresponding to a view angle of −60 degrees to −30 degrees and a video region corresponding to a view angle of +30 degrees to +60 degrees).

According to the embodiment of the present invention, the threshold percentage for determining a surrounding video region may vary according to a communication state and a user's frequency of screen transition. The threshold percentage may be increased with an improvement in the communication state and reduced with a degradation in the communication state.

Also, the threshold percentage may be increased with an increase in the frequency of screen transition of the user of the target user device and may be reduced with a decrease in the frequency of screen transition of the user of the target user device.

Original video data generated through imaging by the video processing device may be video data of a first view angle, and video data is video data of a second view angle. The first view angle may be larger than the second view angle, and the second view angle may be determined by the target user device.

The target user device may generate video information, and the video information may include output video view-angle information indicating the second view angle. The output video view-angle information may include information on the view angle of an output video to be output by the target user device, and the view angle of the output video may be determined on the basis of a direction of the video processing device or an absolute direction.

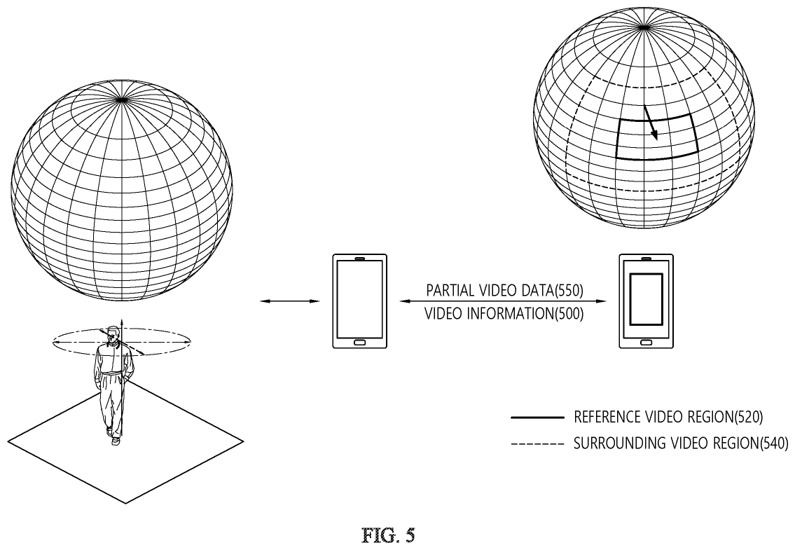

FIG. 5 is a conceptual diagram illustrating a method of transmitting a video through a user device according to an embodiment of the present invention.

FIG. 5 shows a method of reducing the size of transmitted video data in the method of transmitting a video on the basis of a user device. It is assumed below that a video processing device is an omnidirectional video processing device and a video is an omnidirectional video (a 360-degree video).

Referring to FIG. 5, video information 500 for reducing the size of video data may include output video direction information, horizontal output-video view-angle information, and vertical output-video view-angle information.

The output video direction information is information on the imaging direction of a video processing device and may be determined by at least one of a plurality of cameras included in the video processing device. For example, when a user wears a video processing device having a neckband form, a specific direction in which a video captured by a specific camera included in the video processing device (e.g., the forward direction of the user) may be the output video direction.

The horizontal output-video view-angle information may indicate the view angle of a horizontal direction based on the direction indicated by the output video direction information. When an omnidirectional video captured by the video processing device is represented as one sphere, the horizontal direction may be a longitudinal direction. The horizontal output-video view-angle information may include information on a horizontal view angle selected by the target user.

The vertical output-video view-angle information may indicate the view angle of a vertical direction based on the direction indicated by the output video direction information. When an omnidirectional video captured by the video processing device is represented as one sphere, the vertical direction may be a latitudinal direction. The vertical output-video view-angle information may include information on a vertical view angle selected by the target user.

The relay user device may receive the video information 500 including the output video view-angle information, the horizontal output-video view-angle information, and the vertical output-video view-angle information and determine partial video data 550 which is to be transmitted to the target user device on the basis of the video information 500.

For example, the relay user device may transmit not only a reference video region 520 determined on the basis of the output video view-angle information, the horizontal output-video view-angle information, and the vertical output-video view-angle information included in the video information 500 but also a surrounding video region 540 of the reference video region 520 to the target user device.

For example, the reference video region 520 may be a video region corresponding to a first direction, a horizontal output-image view angle of −30 degrees to +30 degrees, and a vertical output-image view angle of −30 degrees to +30 degrees designated by the target user device, and the surrounding video region 540 may be a region obtained by deviating the horizontal output-image view angle (−30 degrees to +30 degrees) from the first direction by a first threshold percentage and deviating the vertical output-image view angle (−30 degrees to +30 degrees) by a second threshold percentage.

When a direction and a view angle at which the target user wants to see are changed, information on the changed direction and the changed view angle may be transmitted from the target user device to the relay user device. In this case, the reference video region 520 and the surrounding video region 540 may be changed.

According to the embodiment of the present invention, the first threshold percentage and/or the second threshold percentage for determining the surrounding video region 540 may vary according to a communication state and/or a user's frequency of screen transition.

The first threshold percentage and/or the second threshold percentage may be increased with an improvement in the communication state and reduced with a degradation in the communication state.

Also, the first threshold percentage and/or the second threshold percentage may be increased with an increase in the frequency of screen transition of the user of the target user device and may be reduced with a decrease in the frequency of screen transition of the user of the target user device.

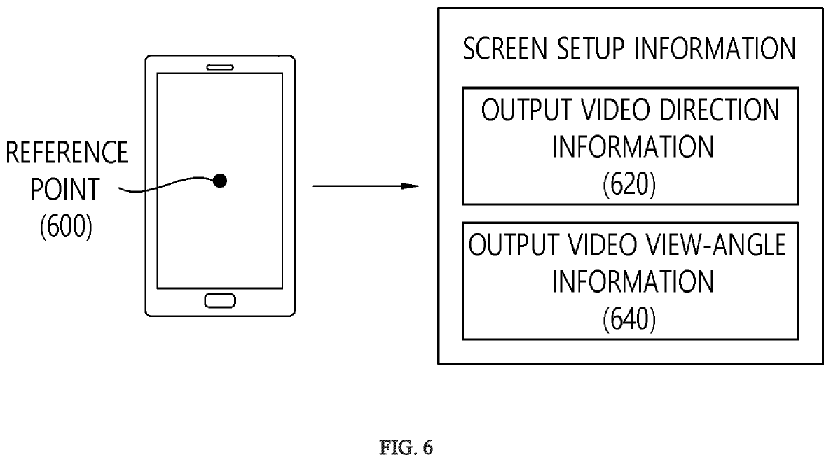

FIG. 6 is a conceptual diagram illustrating a method of checking a video through a remote user device according to an embodiment of the present invention.

FIG. 6 shows a method of automatically adjusting the screen of a target user device for the convenience of viewing the screen of a remote user device.

Referring to FIG. 6, a video captured by a video processing device may be transferred to a target user device through a relay user device or an AP as described above.

The target user device may receive an omnidirectional video and then provide a video to a target user on the basis of a reference point set by the target user.

When a video processing device continuously moves due to motion of a user who wears the video processing device, a user with which a video is shared may feel dizzy. Consequently, the video may be provided to the target user device on the basis of a reference point 600 set by the target user.

For example, the reference point 600 may be set so that a video corresponding to a specific direction, a specific horizontal view angle, and a specific vertical view angle in the received video may be placed at the center of the display of the target user device. In this case, even when the video processing device is changed in location or shaken, a video in which the specific horizontal and vertical view angles and the specific direction are maintained may be provided through the target user device.

Specifically, the target user may set a specific direction and specific horizontal and vertical view angles in the omnidirectional video replayed in the target user device. For example, the target user may set a direction and horizontal and vertical view angles in which the target user wants to see in the omnidirectional video using a touchscreen on the target user device and generate output video direction information 620 and an output video view-angle information 640 as screen setup information by making a specific touch through the user interface.

Such a target user device may output a video indicated by the screen setup information in the omnidirectional video. For example, when the user sets a horizontal view angle of −60 degrees to +60 degrees and a vertical view angle of −45 degrees to +45 degrees on the basis of the reference point 600 and sets X direction as a selection direction on the basis of the video processing device, a screen determined on the basis of the screen setup information in the omnidirectional video may be output. In other words, only a specific region in the omnidirectional video may be output on the target user device, and in this way, the target user device may continuously receive the screen of a specific field of view regardless of real-time motion of the video processing device.

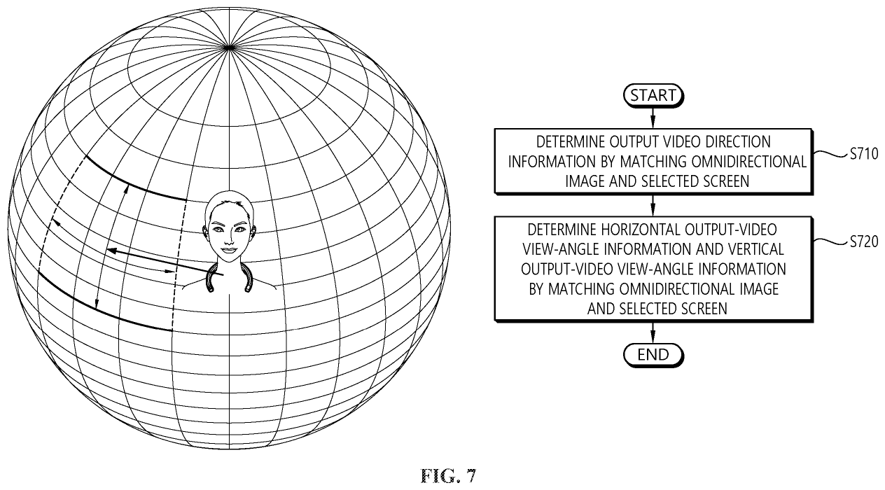

FIG. 7 is a conceptual diagram illustrating a method of receiving a video of a specific field of view selected by a target user according to an embodiment of the present invention.

FIG. 7 shows a method of extracting direction and view angle information of the screen of a specific field of view to be tracked when the screen of the specific field of view is selected by a target user. This may also be applied to the methods of determining output video direction information, horizontal output-video view-angle information, and vertical output-video view-angle information described above with reference to FIGS. 4 and 5.

Referring to FIG. 7, output video direction information may be determined by matching an omnidirectional image and a selected video (step S710).

Direction information may be determined on the basis of a selected screen.

An omnidirectional video image may have a sphere-like shape, and an output video direction in the omnidirectional video image may be set in various ways.

For example, the output video direction may be generated on the basis of the imaging directions of a plurality of cameras included in a video processing device. Assuming that the video processing device is at the center of a sphere, 360-degree direction information may be determined on the basis of a reference direction which is the imaging-line direction of a first camera of the video processing device. Output video direction information may be determined on the basis of which direction a selected screen selected by a user indicates among 360 degrees. An imaging line may be an indication line of a direction indicated by the center of a camera lens.

Alternatively, the output video direction may be a direction relatively determined on the basis of a specific direction (e.g., north) rather than the direction of the video processing device.

Horizontal output-video view-angle information and vertical output-video view-angle information may be determined by matching the omnidirectional image and the selected video (step S720).

The horizontal output-video view-angle information and the vertical output-video view-angle information may be determined to be a horizontal view angle and a vertical view angle on the basis of the output video direction. The horizontal view angle may lie in the longitudinal direction on the sphere, and the vertical view angle may lie in the latitudinal direction on the sphere.

Regardless of motion of the video processing device, a target user may have a field of view of a similar range on the basis of maintenance of such an output video direction, horizontal output-video view-angle, and the vertical output-video view-angle.

A video direction selected by a user may be set on the basis of an absolute position (e.g., north) or set to be a relative position (a forward direction of the user or the imaging line of the first camera) or the like. When the absolute position is selected as the video direction, a video of a specific direction may be continuously received regardless of a directional change of a user who wears the video processing device. On the other hand, when the relative position is selected as the video direction, a video reflecting a directional change of the user who wears the video processing device may be continuously received.

Also, according to an embodiment of the present invention, a video output on a target user device may be changed in consideration of a directional change of the target user device. For example, when the target user device is turned 30 degrees to the left on the basis of a sensor thereof, a screen output on the target user device may be determined by adjusting the view angle of a screen which is currently output on the target user device by −30 degrees and additionally reflecting motion of the target user device.

In addition, according to an embodiment of the present invention, a target user device may provide a function of rotating a video after the video is captured. After an omnidirectional video provided in real time is captured, the omnidirectional video may be rotated on the basis of a touch, and the target user may be provided with screens of various view angles and view fields which are not checked by the target user according to the rotation. When only a partial reference video region and a surrounding video region are provided as described above, omnidirectional video data related to a whole captured video may be transmitted to the target user device after the capture. When an omnidirectional video is provided in real time, the target user may reset a capture function. In this case, the omnidirectional video of a time after the reset may be provided to the target user.

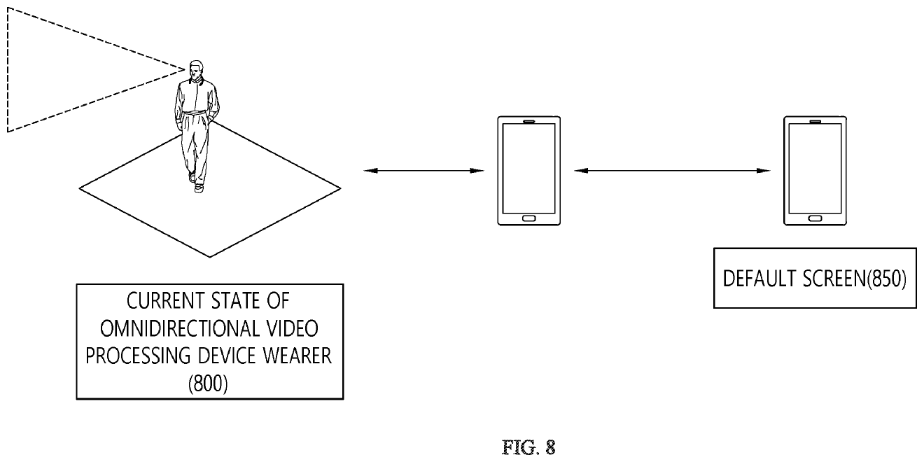

FIG. 8 is a conceptual diagram illustrating a method of checking a video in a target user device according to an embodiment of the present invention.

FIG. 8 shows a method of recommending a region of interest to a target user device. In FIG. 8, a video processing device is assumed to be an omnidirectional video processing device, and a video is assumed to be an omnidirectional video.

Referring to FIG. 8, a recommendation screen may be provided to a target user device so that a target user may receive videos of various view angles. For example, when the target user currently receives a screen having a view angle of −30 degrees to +30 degrees as a selected screen, a screen having another view angle in an omnidirectional video image may be provided as a recommendation screen.

For example, a relay user device or a video processing device may determine a view angle at which many changes are made and provide a screen corresponding to the view angle to the target user as a recommendation screen.

Alternatively, according to an embodiment of the present invention, an optimal view field to be provided to the target user may be detected and provided to the target user.

According to an embodiment of the present invention, as a default screen 850, the target user may receive the same view field as a user who wears an omnidirectional video processing device. The view field of the omnidirectional video processing device wearer may vary according to motion (or a current state 800) of the omnidirectional video processing device wearer, and a change in the view field of the omnidirectional video processing device wearer according to such motion of the omnidirectional video processing device wearer may be learned so that the natural default screen 850 may be provided to the target user.

Specifically, the current state 800 of a user who wears the omnidirectional video processing device may be determined. Regarding motion of the user who wears the omnidirectional video processing device (hereinafter, “omnidirectional video processing device wearer”), a determination may be made such as whether the omnidirectional video processing device wearer is standing, sitting, moving, or walking up the stairs. Motion (or the current state 800) of the omnidirectional video processing device wearer may be determined on the basis of a sensor included in the omnidirectional video processing device. Alternatively, motion (or the current state 800) of the omnidirectional video processing device wearer may be determined on the basis of a video change in the omnidirectional video processing device.

Such motion (the current state 800) of the omnidirectional video processing device wearer may be learned, and current motion (the current state 800) of the omnidirectional video processing device wearer may be determined more accurately on the basis of results of the learning.

The default screen 850 to be currently provided to the target user may be determined on the basis of the current state 800 of the omnidirectional video processing device wearer. For example, when the omnidirectional video processing device wearer who uses an omnidirectional video processing device used as an example in the present invention is standing, a direction of −60 degrees to +60 degrees from the imaging line of the first camera on the front side of the omnidirectional video processing device wearer may be the same as the current view field of the omnidirectional video processing device wearer. In this case, the current state 800 of the omnidirectional video processing device wearer and the view field of the omnidirectional video processing device wearer according to the current state 800 are taken into consideration so that a screen corresponding to a view field which is identical or similar to the view field of the omnidirectional video processing device wearer may be provided to the target user device as the default screen 850. The default screen 850 may be determined by at least one of the omnidirectional video processing device, the relay user device, and the target user device. When the default screen 850 is determined by the relay user device and the target user device, the current state 800 of the omnidirectional video processing device wearer may be determined on the basis of motion sensing information transmitted by the omnidirectional video processing device and a screen change in the omnidirectional video processing device, and the default screen 850 may be provided.

The above-described embodiments of the present invention may be implemented in the form of program instructions executable by various computer elements and recorded in a computer-readable recording medium. The computer-readable recording medium may include program instructions, data files, data structures, etc. alone or in combination. The program instructions recorded on the computer-readable recording medium may be specially designed and configured for the present invention or known to and used by those of ordinary skill in the computer software field. Examples of the computer-readable recording medium include magnetic media, such as a hard disk, a floppy disk, and magnetic tape, optical media, such as a compact disc read-only memory (CD-ROM) and a digital versatile disc (DVD), magneto-optical media, such as a floptical disk, and hardware devices, such as a ROM, a random access memory (RAM), and a flash memory, specially configured to store and perform program instructions. Examples of the program instructions include not only machine language code produced by a compiler but also high-level language code that can be executed by a computer through an interpreter or the like. To perform the operations of the present invention, the hardware devices may be configured as one or more software modules, and vice versa.

While the present invention has been described above with reference to specific details, such as detailed elements, by way of limited embodiments and drawings, these are provided merely to aid the overall understanding of the present invention. The present invention is not limited to the embodiments, and various modifications and changes can be made thereto by those of ordinary skill in the technical field to which the present invention pertains.

Therefore, the spirit of the present invention should not be limited to the above-described embodiments, and the scope of the present invention should be regarded as encompassing not only the following claims but also their equivalents and variations.

1. A video sharing method comprising:
connecting a target user device to a relay user device on the basis of a first communication network; and
receiving, by the target user device, video data, which is generated through imaging by a video processing device, in real time on the basis of the first communication network,
wherein the video processing device and the relay user device are connected on the basis of a second communication network.

2. The video sharing method of claim 1, wherein the first communication network is established on the basis of Internet protocol (IP) address information and port information of the target user device which are set by the relay user device on the basis of port forwarding, and
the second communication network is established on the basis of a hot spot function of the relay user device.

3. The video sharing method of claim 1, wherein original video data generated through imaging by the video processing device is video data of a first view angle,
the video data is video data of a second view angle,
the first view angle is larger than the second view angle, and
the second view angle is determined by the target user device.

4. The video sharing method of claim 3, wherein the target user device generates video information,
the video information includes output video view-angle information indicating the second view angle,
the output video view-angle information includes information on a view angle of an output video to be output from the target user device, and
the view angle of the output video is determined on the basis of a direction of the video processing device or an absolute direction.

5. A target user device for video sharing, comprising:
a communication unit configured to receive video data; and
a processor operatively connected to the communication unit,
wherein the processor is connected to a relay user device on the basis of a first communication network and receives video data, which is generated through imaging by a video processing device, in real time on the basis of the first communication network, and
the video processing device and the relay user device are connected on the basis of a second communication network.

6. The target user device of claim 5, wherein the first communication network is established on the basis of Internet protocol (IP) address information and port information of the target user device which are set by the relay user device on the basis of port forwarding, and
the second communication network is established on the basis of a hot spot function of the relay user device.

7. The target user device of claim 5, wherein original video data generated through imaging by the video processing device is video data of a first view angle,
the video data is video data of a second view angle,
the first view angle is larger than the second view angle, and
the second view angle is determined by the target user device.

8. The target user device of claim 7, wherein the target user device generates video information,
the video information includes output video view-angle information indicating the second view angle,
the output video view-angle information includes information on a view angle of an output video to be output from the target user device, and
the view angle of the output video is determined on the basis of a direction of the video processing device or an absolute direction.
